(19) United States
(12) Patent Application Publication
(10) Pub. No.: US 2008/0120781 A1
(43) Pub. Date: May 29, 2008

(54) DEVICE FOR SUPPORTING A PATIENT IN A PET EXAMINATION

(76) Inventors: Peter Aulbach, Forchheim-Kersbach (DE); Stefan Kaepplinger, Jena (DE)

Correspondence Address: SCHIFF HARDIN, LLP;PATENT DEPARTMENT, 6600 SEARS TOWER, CHICAGO, IL, 60606-6473, US

(21) Appl. No.: 11/770,868

(22) Filed: Jun. 29, 2007

(30) Foreign Application Priority Data
Jun. 30, 2006 (DE) 10 2006 030 808.5

(51) Int. Cl. A61G 7/00; A61G 7/08

(52) U.S. Cl. 5/601

(57) ABSTRACT

A device for supporting of a patient on a patient positioning table that can be inserted into a scanner of a PET system in a PET examination has a vacuum mattress and has an electrically-operated compressor connected to the vacuum mattress. The compressor is controlled with a control device that can be activated with a foot.

### BACKGROUND OF THE INVENTION

1. Field of the Invention

The invention concerns a device for supporting a patient in a PET (Positron Emission Tomography) examination.

2. Description of the Prior Art

In a PET examination, a PET computed tomography (CT) examination or a PET magnetic resonance (MR) examination, the patient is supported by a vacuum mattress on a patient positioning table that can be inserted into the tomography apparatus (scanner). This serves to support and to stabilize the patient during the time-intensive examination in order to enable an optimally untiring immobile support of the patient. Such an untiring support is necessary in order to reduce to a minimum the contraction activity of the muscles and therewith the glucose consumption caused by movement or by straining of the muscles, since this would cause unwanted artifacts in a PET examination.

Before the actual PET examination, the patient is injected with a solution with a sugar compound that has been radioactively marked with a positron emitter. After a wait time that is required in order to metabolize the injected sugar compound, the patient is supported on the patient positioning table of the PET system with the use of the air mattress. At least the upper body (head to trunk) of the patient is stabilized with the air mattress, and therefore it has a relatively large volume. The vacuum mattress must be evacuated to stabilize the position of the patient. In this evacuation procedure the operating personnel must hold the patient in the position to be stabilized with both hands. In order to ensure a correct support of the patient it is often necessary to terminate the procedure and to partially re-inflate the vacuum mattress in order to bring about the desired position of the patient.

At least one hand of the operating personnel must be removed from the patient when the evacuation and inflation ensue with an electrically-operated compressor, since this must be activated and deactivated or switched. Due to this cumbersome procedure, the time that is necessary in order to correctly position the patient is in many cases relatively long. During this time the operating personnel are exposed to the radioactive radiation emanating from the patient.

### SUMMARY OF THE INVENTION

An object of the present invention is to provide a device for supporting of a patient in a PET examination on a patient positioning table with a vacuum mattress that can be inserted into a tomograph of the PET system, which allows a correct and stabilized support of the patient to be achieved in a shorter time.

This object is achieved according to the invention by a device supporting a patient on a patient positioning table that can be inserted into a scanner 9 data acquisition unit) of a PET system in a PET examination, having a vacuum mattress to which is connected an electrically-operated compressor, and a control device that can be activated with a foot is provided to control the compressor.

By this measure, an operation of the compressor is possible without it being necessary for attending personnel to remove one of their hands from the patient. Rather, the operating personnel keeps both hands free in order to optimally shape the vacuum mattress to the body of the patient. This provides for a best-possible and movement-free patient support. Moreover, since an electrically-operated compressor is used, a high suction power and therewith rapid ventilation of the vacuum mattress is possible.

The time (and thus the radiation exposure of the operating personnel) required for the correct positioning of the patient is reduced by the inventive device.

The terms “PET system” and “PET examination” in the following also encompass “PET/CT” and “PET/MR” systems or examinations in which PET methods are combined with CT or MR methods.

A particularly compact design is possible when the compressor is integrated into the patient positioning table.

Moreover, disruptive cable connections are avoided when the compressor can be remotely controlled with the control device via radio transmission form the footswitch.

### BRIEF DESCRIPTION OF THE DRAWINGS

FIG. 1 schematically illustrates a first embodiment of a device according to the present invention.

FIG. 2 schematically illustrates a second embodiment of a device according to the present invention.

### DESCRIPTION OF THE PREFERRED EMBODIMENTS

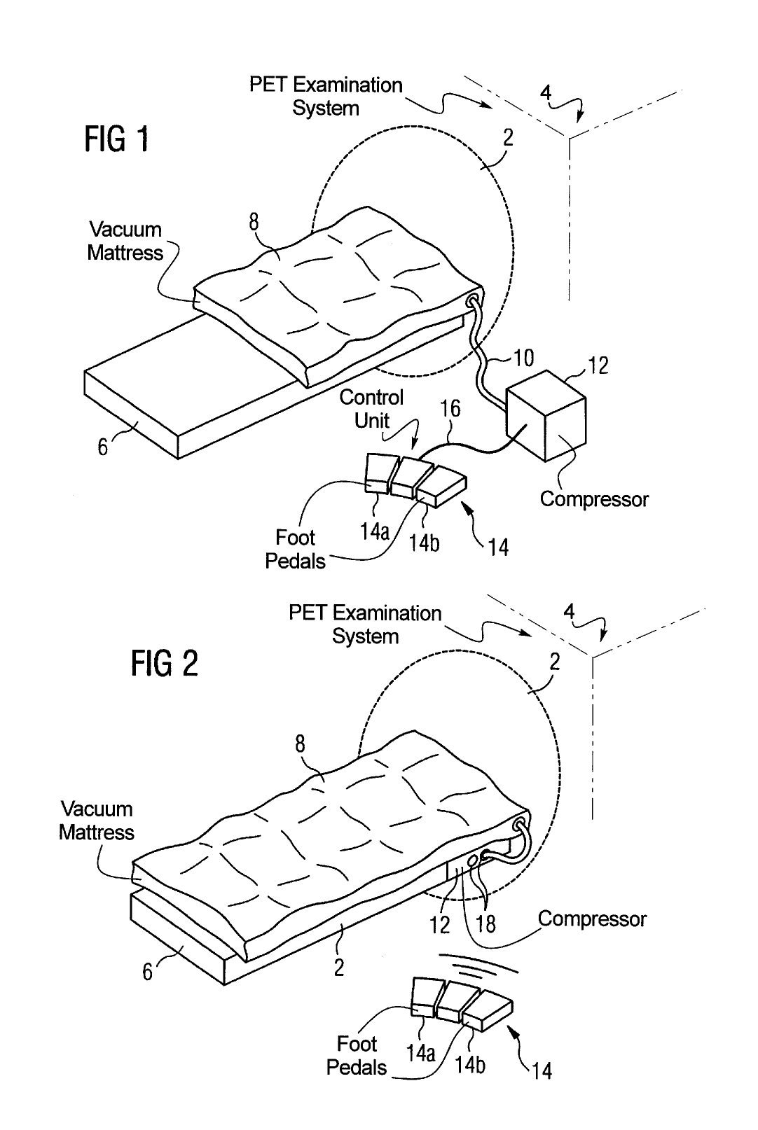

According to FIG. 1, to support a patient in a PET examination, a vacuum mattress 8 that, in the exemplary embodiment, occupies only a portion of the length of a patient positioning table 6, is arranged on the patient positioning table 6. The table 6 with the patient and vacuum mattress 8 therein can be inserted into a PET scanner 2 (only schematically indicated by its opening in FIGS. 1 and 2) of a PET system 4. The vacuum mattress 8 is connected via a suction line 10 with an electrically-operated compressor 12, with which it can be evacuated and if necessary, inflated. The operation of the compressor 12 ensues with a control device 14 that can be actuated with a foot. The control device 14 is electrically connected with the compressor 12 via a control line 16. The control device 14 has two large-area switches 14a, 14b that can be actuated with the foot. The compressor 12 is activated by the first actuation of the first switch 14a. A renewed actuation of the switch 14a stops the compressor so that corrections to the position of the patient can be made during this time. In this case, a return valve located in the suction line 10 between the vacuum mattress 8 and the compressor 12, prevents venting of the vacuum mattress 8. A pressure switch integrated into the compressor 12 automatically deactivates the compressor 12 when a predetermined negative pressure is reached. The negative pressure predominating in the vacuum mattress 8 is continuously monitored so that the compressor 12 can maintain the negative pressure in the case of a pressure rise. The second switch 14b serves for venting the vacuum mattress 8 in order to enable possible required corrections to the support of the patient. Either the operating mode of the compressor 12 is changed from suction to pumping or the return valve is released, upon actuation of the second switch 14b. A fast de-bedding of the patient after termination of the PET examination is possible in this manner.

In the exemplary embodiment according to FIG. 2, the compressor 12 is integrated into the patient positioning table 6, which has one or more connection sockets 18 for standard vacuum mattresses 8. Moreover, in this exemplary embodiment the compressor 12 is controlled with the control device 14 via radio transmission, for example via a Bluetooth link.

Although modifications and changes may be suggested by those skilled in the art, it is the intention of the inventors to embody within the patent warranted hereon all changes and modifications as reasonably and properly come within the scope of their contribution to the art.

We claim as our invention:

1. A patient support device comprising:
a patient positioning table configured to the movable into and out of a scanner of a positron emission tomography system for conducting a positron emission tomography examination;
a vacuum mattress on said patient positioning table, said vacuum mattress being configured to receive and support a positron emission tomography examination subject thereon;
an electrically operated compressor connected to said vacuum mattress and operable to evacuate said vacuum mattress; and
a control device in communication with said compressor, said control device having a foot operated actuator configured to be operated by a foot of an operator to operate said compressor at least to evacuate said vacuum mattress.

2. A device as claimed in claim 1 wherein said compressor is integrated into said patient positioning table.

3. A device as claimed in claim 1 wherein said control device comprises a radio transmitter that operates said compressor by radio transmission of control signals to said compressor.

4. A device as claimed in claim 1 wherein said compressor is operable in reverse to vent said vacuum mattress, and wherein said control device is also operable by foot to place said compressor in the reverse operation to vent said vacuum mattress.

5. A device as claimed in claim 4 wherein said control device comprises a first foot pedal that is actuatable by foot to operate said compressor to evacuate said vacuum mattress, and a second foot pedal that is operable by foot to place said compressor in said reverse operation.

6. A device as claimed in claim 1 comprising a connecting line between said compressor and said vacuum mattress, and a venting valve in said connecting line that is actuatable to vent said vacuum mattress, and wherein said control unit is also operable by foot to actuate said venting valve.

7. A device as claimed in claim 6 wherein said control device comprises a first foot pedal that is operable by foot to operate said compressor to evacuate said vacuum mattress, and a second foot pedal that is operable by foot to actuate said venting valve to vent said vacuum mattress.
